(19) United States
(12) Patent Application Publication
(10) Pub. No.: US 2004/0100800 A1
(43) Pub. Date: May 27, 2004

(54) Night lamp device

(76) Inventor: Yi-Fa Wang, Taichung (TW)

Correspondence Address: Charles E. Baxley, Esquire, 5th Floor, 59 John Street, New York, NY, 10038, US

(21) Appl. No.: 10/303,233

(22) Filed: Nov. 25, 2002

(51) Int. Cl. F21V 1/00; F21V 29/00; H01R 33/00

(52) U.S. Cl. 362/353; 362/226; 362/294

(57) ABSTRACT

A night lamp device includes a lamp socket having an outer surrounding wall to confine a bulb receiving cavity for receiving a lamp bulb, and upper and lower retaining members disposed on the outer surrounding wall. An electrical plug is mounted to and projects outwardly from the socket. A lamp shade includes a bottom end wall having an opening and a plurality of air inlets surrounding the opening, and is retained on the outer surrounding wall by a retained segment which is clamped between the retaining members. A shade surrounding wall extends from the bottom end wall, and has a plurality of ventilating holes so as to ventilate an accommodation chamber confined by the lamp shade.

### FIELD OF THE INVENTION

This invention relates to a night lamp device, more particularly to a night lamp device with a lamp shade formed from a resilient foam material and having a plurality of air inlets for introducing air to cool hot air to cool hot air in an accommodation chamber confined by the lamp shade.

### BACKGROUND OF THE INVENTION

A conventional night lamp device generally includes a plastic lamp socket for receiving a lamp bulb, and a plastic lamp shade mounted to the lamp socket for shielding the lamp bulb. In use, adjoining portions of the lamp shade and the lamp socket may become burnt due to heat emanating from the lamp bulb. In addition, as the lamp shade has to be formed by a heat-resistant material, it cannot have a variety of shapes.

### SUMMARY OF THE INVENTION

The object of the present invention is to provide a night lamp device in which heat emanating from a lamp bulb can be dissipated, and in which a lamp shade can be configured to have a variety of shapes.

According to this invention, the night lamp device includes a lamp socket, an electrical plug, and a lamp shade. The lamp socket has an outer surrounding wall which surrounds an axis in a longitudinal direction and which confines a bulb receiving cavity therein that is adapted to receive a lamp bulb, and upper and lower retaining members which are disposed on the outer surrounding wall and which are spaced apart from each other in the longitudinal direction. An electrical plug is mounted to and is electrically connected to the lamp socket, and projects outwardly from the outer surrounding wall in a transverse direction relative to the longitudinal direction so as to be adapted for electrical connection with an electrical outlet. A lamp shade is removably mounted to the lamp socket, and includes a bottom end wall and a shade surrounding wall. The bottom end wall has an inner peripheral wall surface which surrounds the axis and which confines an opening to permit the bottom end wall to abut against the lower retaining member, and a plurality of air inlets which are displaced angularly from one another about the axis. Each air inlet extends radially and outwardly from the inner peripheral wall surface, and is configured to permit the upper retaining member to pass therethrough in the longitudinal direction. A retained segment is defined between two adjacent ones of the air inlets. The bottom end wall is turnable about the axis between a released position where the upper retaining member is registered with one of the air inlets to permit the upper retaining member to pass through the air inlet, and a clamped position where the retained segment is clamped between the upper and lower retaining members. The shade surrounding wall extends from an outer periphery of the bottom end wall in the longitudinal direction, and confines therein an accommodation chamber which is adapted for shielding the lamp bulb. The shade surrounding wall has a plurality of ventilating holes which are in fluid communication with the air inlets through the accommodation chamber. Air can be introduced into the accommodation chamber via the air inlets to carry away hot air in the accommodation chamber via the ventilating holes.

### BRIEF DESCRIPTION OF THE DRAWINGS

Other features and advantages of the present invention will become apparent in the following detailed description of the preferred embodiment of the invention with reference to the accompanying drawings, in which:

FIG. 1 is an exploded perspective view of a preferred embodiment of a night lamp device according to this invention;

FIG. 2 is a perspective vies of the preferred embodiment in a released state;

FIG. 3 is a sectional vies of the preferred embodiment in a retained state; and

FIG. 4 is a cross-sectional vies of the preferred embodiment, taken along lines 4-4 of FIG. 3.

### DETAILED DESCRIPTION OF THE PREFERRED EMBODIMENT

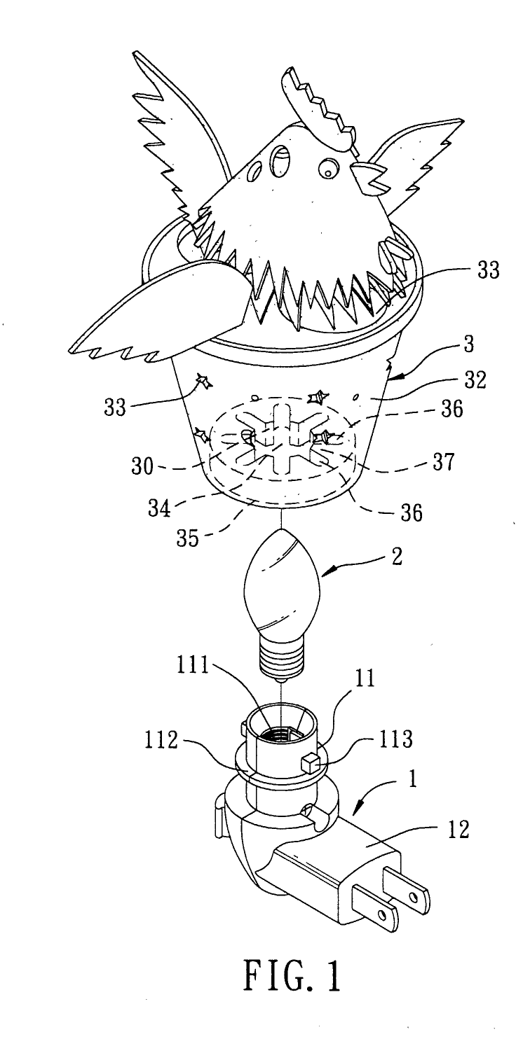

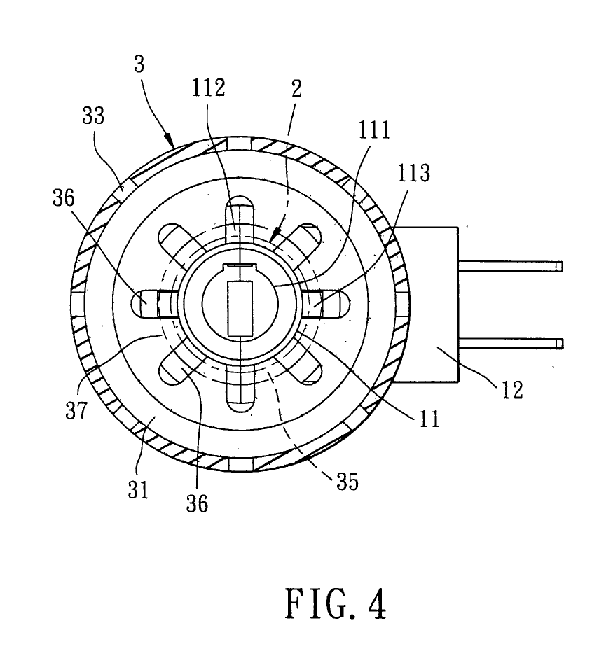

Referring to FIGS. 1 to 4, the preferred embodiment of a night lamp device according to the present invention is shown to comprise a lamp socket 1, a lamp bulb 2 an electrical plug 12, and a lamp shade 3.

The lamp socket 1 has an outer surrounding wall 11 which surrounds an axis in a longitudinal direction and which confines a bulb receiving cavity 111 therein, and upper and lower retaining members 113,112 which are disposed on the outer surrounding wall 11 and which are spaced apart from each other in the longitudinal direction. The upper retaining member 113 is in the form of a pair of ribs, and the lower retaining member 112 is in the form of an annular ring.

The lamp bulb 2 is mounted to the lamp socket 1 and is connected electrically to the lamp bulb 2 when the lamp bulb 2 is received in the bulb receiving cavity 111. The electrical plug 12 projects outwardly from the outer surrounding wall 11 of the lamp socket 1 in a transverse direction relative to the longitudinal direction so as to be adapted for electrical connection with an electrical outlet (not show).

The lamp shade 3 is formed from a resilient foam material, preferably a flame retardant foam material, such as ethyl vinyl acetate (EVA). The lamp shade 3 is removably mounted to the lamp socket 1 to surround the lamp bulb 2, and includes a bottom end wall 35 and a shade surrounding wall 32.

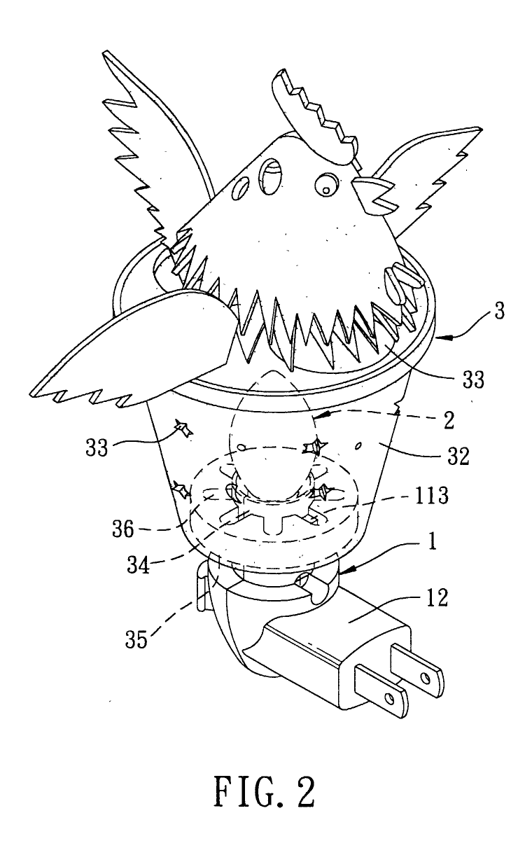

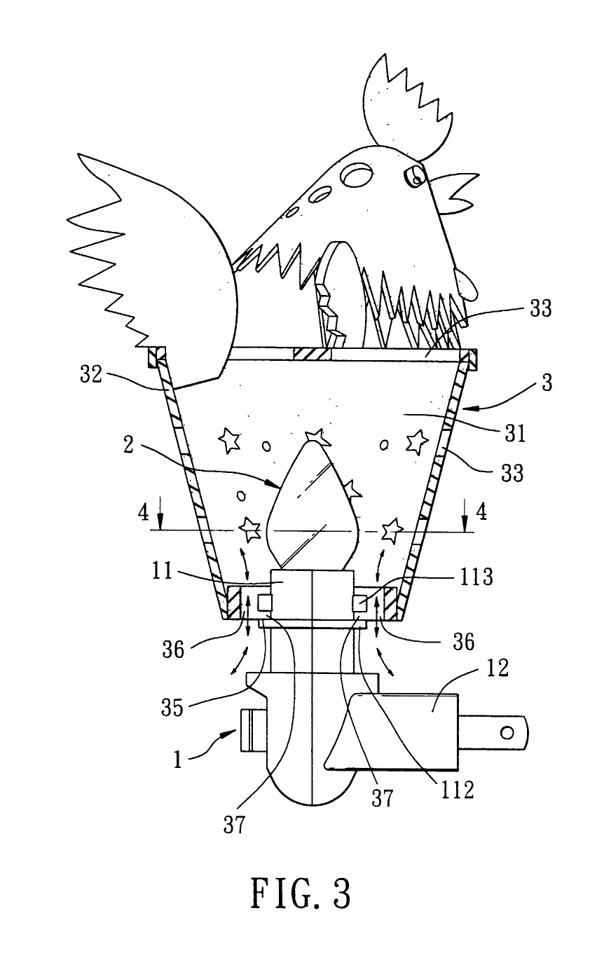

The bottom end wall 35 has an inner peripheral wall surface 30 which surrounds the axis and which confines an opening 34 that is configured to permit the bottom end wall 35 to abut against the lower retaining member 112. A plurality of air inlets 36 are formed in the bottom end wall 35, and are displaced angularly from one another about the axis. Each of the air inlets 36 extends radially and outwardly from the inner peripheral wall surface 30, and is configured to permit the upper retaining member 113 to pass therethrough in the longitudinal direction. Thus, the bottom end wall 35 is formed with a plurality of retained segments 37, each of which is defined between two adjacent ones of the air inlets 36. As such, the lamp shade 3 is turnable about the axis between a released position, where the upper retaining member 113 is registered with two of the air inlets 36 to permit the upper retaining member 113 to pass through the air inlets 36, as shown in FIGS. 2 and 3, and a clamped position, where two of the retained segments 37 are clamped between the upper and lower retaining members 113,112 so as to retain the lamp shade 3 relative to the lamp socket 1.

The shade surrounding wall 32 extends from an outer periphery of the bottom end wall 35 in the longitudinal direction, and confines therein an accommodation chamber 31 for shielding the lamp bulb 2. The shade surrounding wall 32 has a plurality of ventilating holes 33 which are in fluid communication with the air inlets 36 through the accommodation chamber 31. As such, air can enter into the accommodation chamber 31 via the air inlets 36 to carry away hot air in the accommodation chamber 31 via the ventilating holes 33.

As illustrated, by means of the air inlets 36 and the ventilating holes 33 for ventilating the accommodation chamber 31, heat emanating from the lamp bulb 2 can be dissipated, thereby preventing the bottom end wall 35 of the lamp shade 3 and the outer surrounding wall 11 of the lamp socket 1 from becoming burnt. Moreover, as the lamp shade 3 is formed from a resilient foam material, such as EVA, it can be configured to have a variety of shapes.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A night lamp device comprising:
a lamp socket having an outer surrounding wall which surrounds an axis in a longitudinal direction and which confines a bulb receiving cavity therein that is adapted to receive a lamp bulb, and upper and lower retaining members which are disposed on said outer surrounding wall and which are spaced apart from each other in the longitudinal direction;
an electrical plug mounted to and electrically connected to said lamp socket, and projecting outwardly from said outer surrounding wall in a transverse direction relative to the longitudinal direction so as to be adapted for electrical connection with an electrical outlet; and
a lamp shade removably mounted to said lamp socket, and including
a bottom end wall having an inner peripheral wall surface which surrounds the axis and which confines an opening that is configured to permit said bottom end wall to abut against said lower retaining member, and a plurality of air inlets which are displaced angularly from one another about the axis, each of said air inlets extending radially and outwardly from said inner peripheral wall surface and being configured to permit said upper retaining member to pass therethrough in the longitudinal direction, said bottom end wall including a retained segment which is defined between two adjacent ones of said air inlets, and being turnable about the axis between a released position where said upper retaining member is registered with one of said air inlets to permit said upper retaining member to pass through said one of said air inlets, and a clamped position where said retained segment is clamped between said upper and lower retaining members, and
a shade surrounding wall extending from an outer periphery of said bottom end wall in the longitudinal direction, and confining therein an accommodation chamber which is adapted for shielding said lamp bulb, said shade surrounding wall having a plurality of ventilating holes which are in fluid communication with said air inlets through said accommodation chamber such that air is introduced into said accommodation chamber via said air inlets to carry away hot air in said accommodation chamber via said ventilating holes.

2. The night lamp device of claim 1, wherein said lamp shade is formed from a flame retardant foam material.
